(19) United States
(12) Patent Application Publication
(10) Pub. No.: US 2021/0372090 A1
(43) Pub. Date: Dec. 2, 2021

(54) Boom Extension and Rotation Monitoring System

(71) Applicant: Manitou Equipment America, LLC, West Bend, WI (US)

(72) Inventor: Kyle Ressler, West Bend, WI (US)

(21) Appl. No.: 16/890,519

(22) Filed: Jun. 2, 2020

(51) Int. Cl. E02F 9/26; E02F 9/22; B66F 9/075; B66F 9/08; B66F 9/06; B66F 9/065; E02F 3/28

(52) U.S. Cl. CPC E02F 9/265; E02F 9/2246; E02F 9/226; E02F 3/286; B66F 9/082; B66F 9/061; B66F 9/0655; B66F 9/0755

(57) ABSTRACT

An infrared light-transmitting system for determining the position (e.g., angle and extension) of a boom is provided. The system includes a vehicle with wheels or a track that move the cab. A chassis or frame supports the cab and boom. In various embodiments, the boom extends and rotates; for example, the boom can rotate in 1 or 2 dimensions. The boom interconnects the chassis at the first end to the attachment at the second end. At least one pivot couples the boom to the chassis to rotate the boom about the pivot relative to the chassis. A transmitter emits infrared light signals that are reflected off a reflector to a detector to determine the real-time position of the attachment and/or boom.

### BACKGROUND OF THE INVENTION

The present invention relates generally to the field of booms for cranes, telehandlers, loaders, and the like. The present invention relates specifically to a system of determining the extension and angle of a rotated and/or extended boom on the vehicle. Telehandler boom extension monitoring ensures that the load is counterbalanced and may prevent tipping.

In general, many different types of heavy machinery include rotating and/or telescoping booms, including but not limited to loaders, skid steers, boom handlers, etc. Operators generally use heavy equipment with telescoping booms for construction, farming, and other tasks. Many of these vehicles include a hydraulic actuator that extends and/or pivots the boom relative to the vehicle.

### SUMMARY OF THE INVENTION

One embodiment of the invention relates to a light-transmitting system for determining an angle and an extension of a rotating and telescoping boom. The system includes a base, a telescoping boom, a pivot, a reflector, a transmitter, and a detector. The telescoping boom has a first end coupled to the base and a second end extending away from the base. The pivot couples the telescoping boom to the base to facilitate rotation of the telescoping boom relative to the base. The reflector is located on either the base or the second end of the telescoping boom. The transmitter and detectors are located opposite the reflector on either the base or the second end of the telescoping boom, such that the detector is adjacent to the transmitter.

Another embodiment of the invention relates to an infrared light transmitting system for determining an angle and an extension of a rotating and telescoping boom. The system includes a chassis, a telescoping boom, a pivot, a reflector, a transmitter, and a detector. The telescoping boom has a first end coupled to the chassis and a second end extending away from the chassis. The pivot couples the telescoping boom to the chassis that rotates the telescoping boom relative to the chassis. The reflector is located on either the chassis or the second end of the telescoping boom. The transmitter and detector are located at the opposite end of the telescoping boom on either the chassis or the second end of the telescoping boom. The detector is located adjacent to the transmitter.

Another embodiment of the invention relates to an infrared light transmitting system for determining an angle and an extension of a rotating and telescoping boom. The system includes a vehicle, a telescoping boom, a pivot, a reflector, a transmitter, and a detector. The vehicle includes wheels to move or drive the vehicle, a cab that at least partially surrounds an operator of the vehicle, and a chassis that supports the cab and couples to the wheels. The telescoping boom interconnects the chassis at the first end to an attachment extending away from the chassis at the second end. The pivot couples the telescoping boom to the chassis. The telescoping boom rotates about the pivot relative to the chassis. The reflector is on the vehicle or the attachment. The transmitter is opposite the reflector, and the detector is adjacent to the transmitter.

Alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a telehandler with a light-sensing system configured to sense the extension and rotation of the telescoping boom, according to an exemplary embodiment.

FIG. 2 is a detailed view of a light reflector on a second end of the telescoping boom, according to an exemplary embodiment.

FIG. 3A is a view from outside of the cab of FIG. 1 illustrating a light transmitter and a light detector located within the cab, according to an exemplary embodiment.

FIG. 3B is a view of the inside of the cab of FIG. 3A, illustrating the transmitter and the detector located inside of the cab window.

FIG. 4A is a front view of a transmitter, according to an exemplary embodiment.

FIG. 4B is a side view of the transmitter of FIG. 4A.

FIG. 5 shows various reflector shapes that identify different attachments, according to an exemplary embodiment.

FIG. 6 is a side view of a vehicle, such as a skid steer loader, with arms supporting a bucket in a raised position, according to an exemplary embodiment.

FIG. 7 illustrates the vertical lift path for a bucket attached to the lift arms of a skid steer loader, according to an exemplary embodiment.

FIG. 8 is a perspective view of a vehicle, such as a telehandler, with a partially rotatable and extendable boom coupled to a fork tyne attachment, according to an exemplary embodiment.

FIG. 9 is a tracked loader vehicle with rotating arms for lifting a bucket, according to an exemplary embodiment.

FIG. 10 is a digital load chart that is configured based upon date representing the extension and/or rotation of the associated telescoping boom, according to an exemplary embodiment.

### DETAILED DESCRIPTION

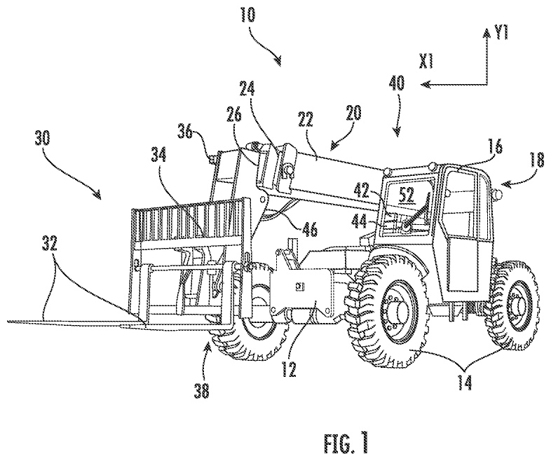

Referring to FIG. 1, a telehandler 10 includes an operator a chassis 12 which is movably supported by wheels 14 which are all typically capable of pivoting relative to chassis 12. Wheels 14 are powered by an engine and hydraulic system (not shown) to move chassis 12. An operator cab 16 is supported by chassis 12 adjacent to a pivot structure 18 for a boom 20. Boom 20 includes a base section 22 attached to pivot structure 18 and one or more hydraulic rams for rotating a base section 22 of boom 20 relative to pivot structure 18. Fluid is applied to the hydraulic ram by the hydraulic system, and an appropriate operator controlled valve. For example, hydraulic ram is a hydraulic extension and/or rotation cylinder to operate boom 20.

Boom 20 includes base section 22, a middle section 24, and an end section 26. End section 26 is coupled to an attachment 30. Attachment 30 includes tynes 32 and a platform 34 for lifting a workload. A hydraulic extension ram is located inside of boom 20, and attached to the three boom sections (e.g., base section 22, middle section 24, and end section 26). Hydraulic extension ram controllably extends boom 20 by telescoping the sections relative to each other as the hydraulic fluid is provided to the hydraulic extension ram by appropriate operator controlled valve. Attachment 30 is pivotally attached to the end of boom 20 (e.g., end section 26 furthest from pivot structure 18). An attachment pivot 36 and a hydraulic cylinder control the rotation of attachment 30 relative to the end of boom 20 (e.g., end section 26) in response to hydraulic fluid applied to the cylinder by the hydraulic system and associated operator controlled valve. A load sensor 38 can determine the weight of the load on attachment 30.

A light system 40 includes a transmitter 42, a detector 44, a reflector 46, and a controller 48. The transmitter emits light beams or traces 50 that are reflected off reflector 46 and detected at detector 44. Transmitter 42 and detector 44 are located in a window 52 of cab 16. Transmitter 42 transmits trace 50, and detector 44 detects the time for trace 50 to travel back from reflector 46 on attachment 30. Controller 48 uses the direction and time of the detected trace 50 to determine extension and height components X1 and Y1 of attachment 30. For example, as boom 20 extends and/or rotates light system 40 measures and calculates extension and height components X1 and Y1 of attachment 30 relative to cab 16.

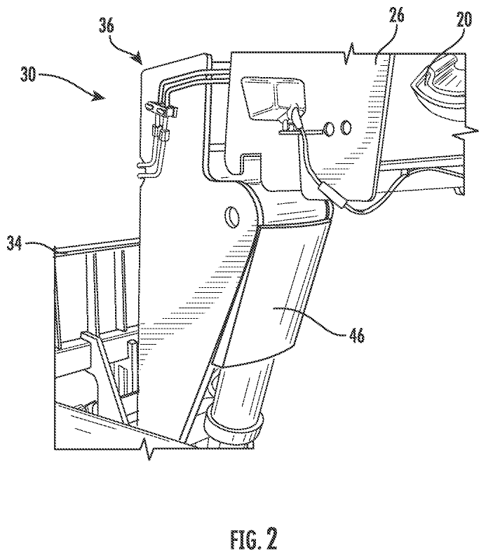

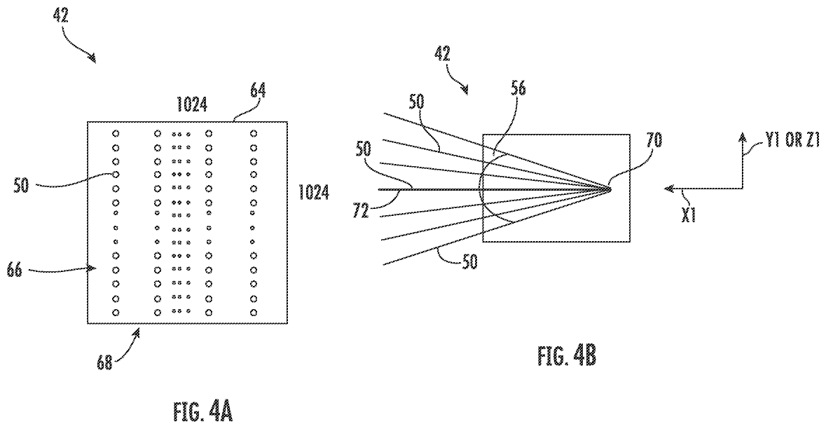

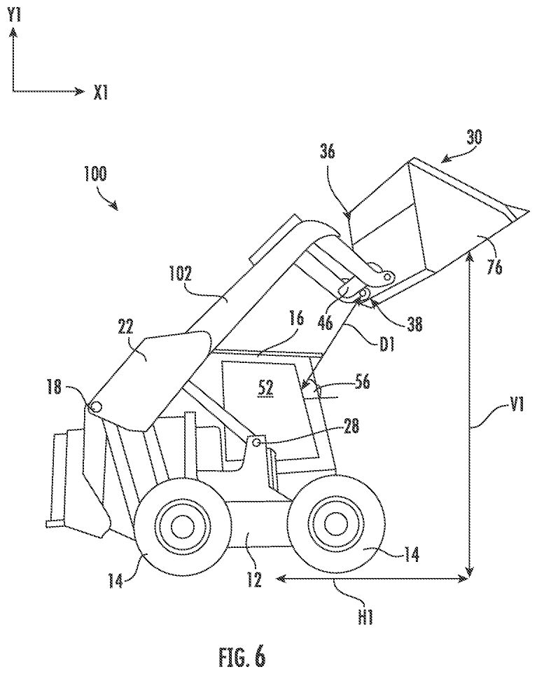

FIG. 2 shows reflector 46 coupled on attachment 30. System 40 transmits light (e.g., infrared light) that is reflected off reflector 46 to determine the extension and height components X1 and Y1 of attachment 30. System 40 measures the time it takes for trace 50 (FIG. 4) to travel from transmitter 42 to reflector 46 and back to detector 44. The measured time indicates a straight-line distance D1 (FIG. 6) between reflector 46 and detector 44. System 40 maintains a line of sight between reflector 46 and cab 16, such that trace 50 from transmitter 42 is reflected to detector 44. In various embodiments, reflector 46 may be located on other parts of attachment 30 and/or end section 26 to maintain a line of sight regardless of the location of attachment 30 relative to transmitter 42 and detector 44.

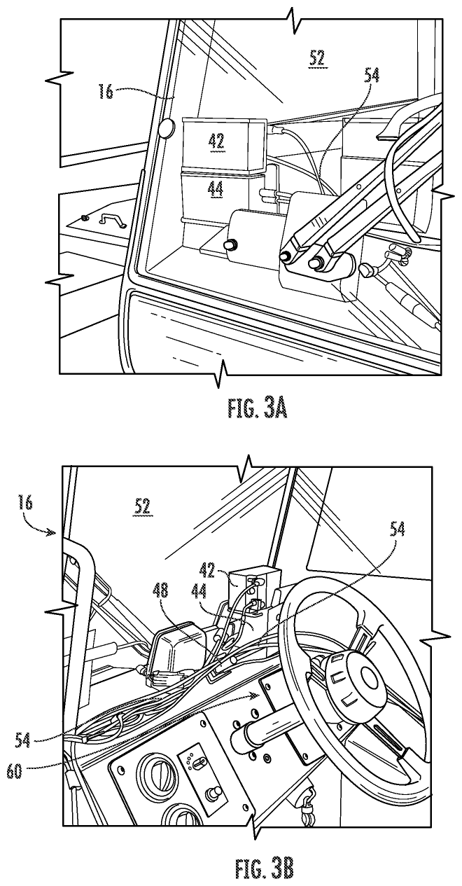

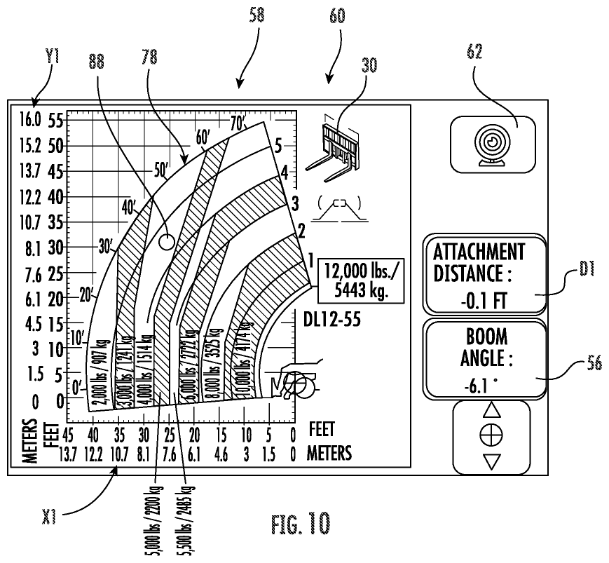

FIGS. 3A and 3B show different perspective views of transmitter 42 and detector 44 located within cab 16. Transmitter 42 and/or detector 44 are located inside window 52 of cab 16. Wires 54 provide power to transmitter 42 and/or detector 44 and electrically couple system 40 to a central processing unit, such as controller 48. Controller 48 calculates extension and height components X1 and Y1 of boom 20 based on the measured time and angle 56 (FIG. 4B) of trace 50. Controller 48 determines a threshold limit for extension and/or height components X1 and/or Y1. For example, system 40 generates a load chart 58 (FIG. 10) on display 60. Load sensor 38 detects a load applied on attachment 30, and controller 48 calculates limits for extension and/or height components X1 and/or Y1. Display 60 dynamically updates load chart 58 to show the position of extension and height components X1 and Y1 relative to the calculated limits during rotation and/or extension of boom 20. When boom 20 extension is at or near a threshold, controller 48 sounds an alarm 62 and/or limits the further extension of boom 20.

FIG. 4A shows a front or face of transmitter 42 having a matrix 64 of traces 50 oriented in vertical arrays 66 and horizontal arrays 68. Each emitted trace 50 has an assigned angle 56, and transmitter 42 forms a matrix 64 of vertical arrays 66 and horizontal arrays 68 of traces 50. For example, FIG. 4A shows a square matrix 64 of 1,024 traces 50 aligned in vertical and horizontal arrays 66 and 68.

FIG. 4B is a schematic of a side of transmitter 42 emitting individual traces 50 at different angles 56. Traces 50 originate and are angled from a focal point 70. Transmitter 42 emits traces 50 in a variety of angles 56 (e.g., from 0° to 45° or 0° to 90°) relative to a horizontal or X-axis 72 extending from cab 16 and parallel to the ground. Trace 50 reflects onto detector 44 at angle 56 and controller 48 calculates extension and height components X1 and Y1 (e.g., X and Y coordinates) based on angle 56 and the straight line distance D1.

FIG. 4B is a schematic of a top of transmitter 42. Transmitter 42 measures an out-of-plane component Z1. Transmitter 42 forms angles 56 with emitted traces 50 to determine a Z coordinate that corresponds to out-of-plane rotation (e.g., into and out of the page of FIG. 6). Accordingly, transmitter 42 can determine a 3D position of boom 20 and emits traces 50 at an angle 56 relative to any reference axis (e.g., X-axis, Y-axis, or Z-axis). The position of attachment 30 includes the extension, height, and out-of-plane components X1, Y1, and Z1 (e.g., X, Y, and/or Z coordinates) measured from transmitter 42 and/or detector 44 to reflector 46.

Matrix 64 has a number of traces 50 in vertical array 66 that is greater than the number of traces 50 in horizontal array 68. This configuration enhances the resolution of extension component X1 and height component Y1 but limits the resolution of out-of-plane component Z1. Boom 20 has one pivot structure 18 to rotate boom 20 in the X-Y plane (e.g., the plane formed by extension and height components X1 and Y1). In a specific embodiment, transmitter 42 has a matrix 64 of traces 50 with a width dimension (e.g., horizontal array 68) that is equal to or less than one-fourth a height dimension (e.g., vertical array 66).

Transmitter 42 may include traces 50 angled downward. For example, some traces 50 reflect off the ground. Detector 44 senses reflected traces 50 off the ground, and controller 48 calculates the levelness and/or slope of the ground surrounding wheels 14 and/or chassis 12. For example, the load supported by boom 20 could become unstable if the operator drives on a slope or into the hole. When detector 44 calculates the deviation in the ground, detector 44 sends a signal to controller 48 to stop the operation of wheels 14. Controller 48 stops operation of wheels 14 when the ground has a hole or deviation that exceeds a threshold. For example, if the deviation is greater than 2″, 3″, 4″, 5″, 6″, a foot or more. An operator can set the deviation level (e.g., hole depth or ground slope), and controller 48 alerts the operator and/or stops operation of wheels 14, boom 20, and/or vehicle when the established deviation level is sensed and/or calculated.

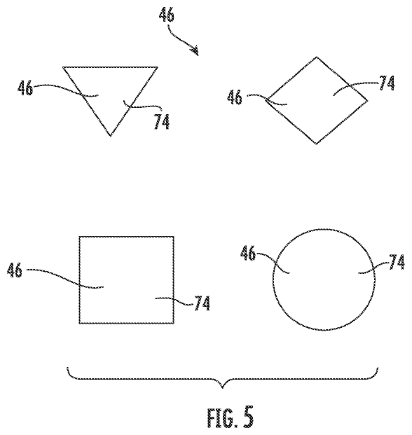

FIG. 5 shows various reflectors 46 having different shapes 74 and/or colors. Different colors and/or shapes 74 identify different attachments 30 for controller 48 and/or operator. As attachment 30 moves, traces 50 are reflected off reflector 46 and identify the shape 74 of reflector 46. Different shapes 74 of reflector 46 are associated with different attachments 30 coupled to boom 20. For example, a dimension of attachment 30 associated with shape 74 communicates information to controller 48 regarding attachment 39, such as weight, height, width, and/or length dimensions of attachment 30.

FIG. 6 is a side view of another vehicle such as a skid steer 100. System 40 works with a rotated loader or lift arm 80 of skid steer 100 in much the same way as it does an extended and rotated boom 20 of telehandler 10 (FIG. 1). System 40 measures bucket 76 extension and height components X1 and Y1 in vertical V1 and horizontal H1 dimensions as a load or lift arm 80 is rotated about pivot structure 18.

In operation, detector 44 identifies a distance D1 and angle 56 formed between lift arm 80 and ground. The time of travel for the reflected traces 50 from transmitter 42 to reflector 46 and back to detector 44 establishes distance D1. Controller 48 uses right-triangle geometry to solve for the X and Y coordinates of bucket 76 (or other attachment 30).

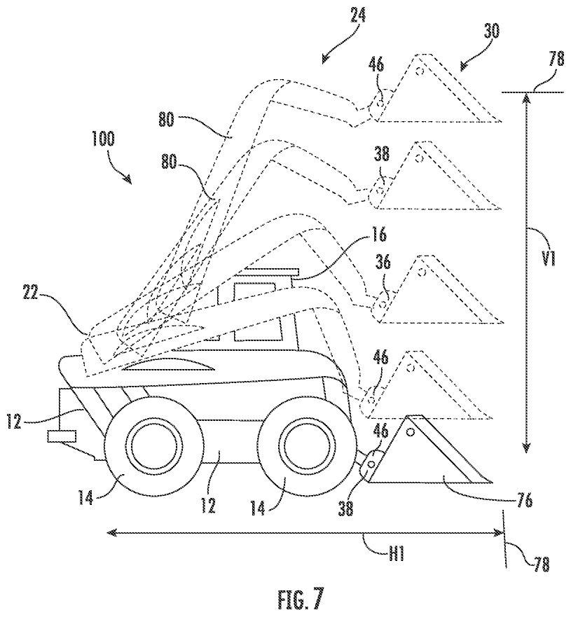

FIG. 7 is a ghost-line representation of vertical components V1 in a lift path for bucket 76. In other words, system 40 can determine a vertical V1 height dimension, independent from a horizontal H1 dimension. Reflector 46 is located on bucket 76. Transmitter 42 and detector 44 are located adjacent to one another inside cab 16 to determine the height of the elevated bucket 76. FIG. 7 also shows controller 48 calculated horizontal and vertical limits 78. For example, an extension of bucket 76 beyond limit 78 causes alarm 62 to sound and/or controller 48 prevents further extension and/or rotation of lift arm 80.

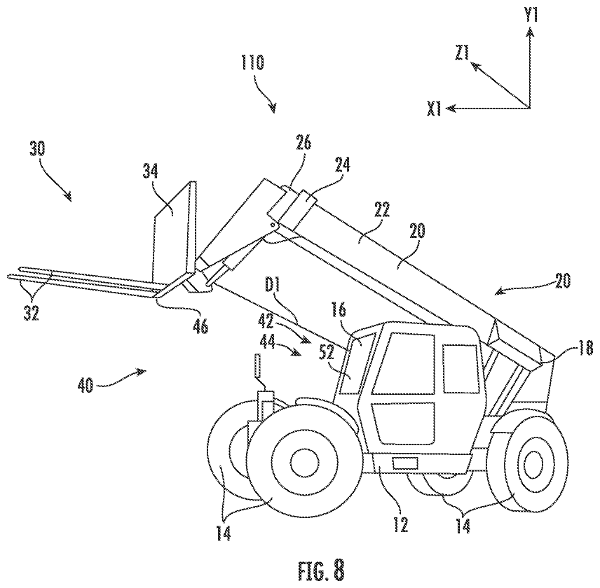

FIG. 8 is a perspective view of another telehandler vehicle or articulated loader 110. In various embodiments, articulated loader 110 may be a fixed boom, a rotational (e.g., 3D), or a heavy lift telehandler. Articulated loader 110 has a partially rotated and extended boom 20 coupled to fork tyne 32 attachment 30. Attachment 30 includes a platform 34 and a pair of tynes 32 that removably support platform 34. For example, a pallet load is rotated and supported against platform 34 on a backside of tynes 32. In one embodiment, reflector 46 is located on at least one tyne 32 and transmitter 42 and detector 44 are located inside cab 16. In other embodiments, platform 34 includes a floor with surrounding rails, such as an operator lift.

System 40 includes transmitter 42, detector 44, reflector 46, and controller 48. For example, transmitter 42 sends infrared light beam traces 50 that are reflected off reflector 46 and sensed by detector 44. Detector 44 senses traces 50 reflected off other objects, e.g., without a reflector 46. Controller 48 calculates and/or determines the location of the object that reflected the trace 50. Applicant has found that infrared light traces 50 reflect off such objects located between chassis 12 and an extended end of boom 20 supporting attachment 30. For example, when detector 44 senses a person entering the space between cab 16 and attachment 30, controller 48 sends a signal that stops the movement of wheels 14 and/or boom 20.

FIG. 8 shows a an articulated loader 110 with an angled cab 16. In other words, articulated loader 110 moves boom 20 relative to cab 16 in all three dimensions, e.g., movement in X, Y, and Z dimensions. Movement of boom 20 in the Z dimension can be accomplished by steering angled cab 16 and/or rotating boom 20 in two or more dimensions (e.g., up and down and into and out of the page). For example, the distance D1 measurement between attachment 30 and angled cab 16 in FIG. 8 includes extension component X1, height component Y1, and out-of-plane component Z1.

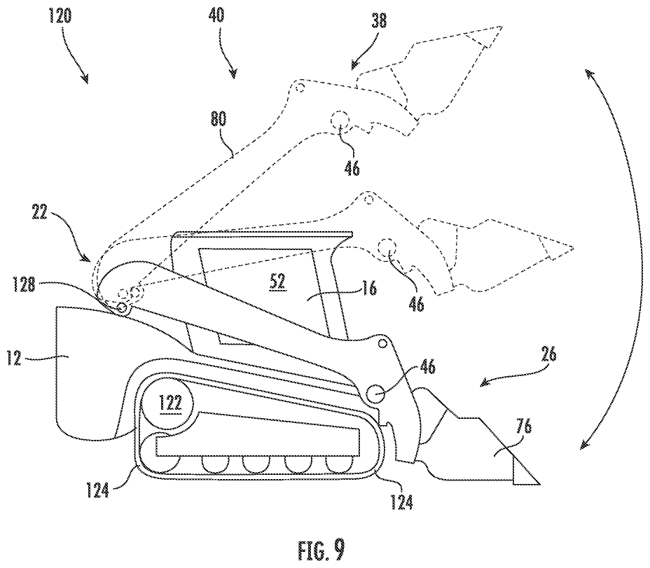

FIG. 9 shows another embodiment of a track loader 120 with rotating lifter 82. Wheel hubs 122 can couple to track 124 to move or drive track loader 120. System 40 is implemented in a two-dimensional design to measure the rotation of lifter 82 about pivot 126. In this embodiment, lifter 82 rotation results in radial bucket 128 movements.

FIG. 10 is a digital and/or dynamic load chart 58 loaded onto a display 60. A dynamic digital load chart 58 is dynamically updated based on information received from load sensor 38 and the extension and/or rotation of attachment 30 on, e.g., boom 20, lift arm 80, and/or lifter 82. For example, the sensed weight at load sensor 38 and the extension and/or rotation of boom 20 is calculated by controller 48 in real-time, during vehicle operation. Controller 48 updates load chart 58 to provide audio/visual alarms 62 and/or warnings. FIG. 10 shows an attachment distance D1 and angle 56. For example, the operator selects whether X, Y, and Z components or distance D1 and angle 56 are displayed on load chart 58 and/or display 60.

Display 60 dynamically illustrates load chart 58 for various weights (white and grey shading) on display 60 in cab 16. Display 60 shows the operator horizontal and/or vertical limits 78 in real-time based on information received from load sensor 38 and/or detector 44. For example, the current position 88 of attachment 30 is illustrated within load chart 58 and updated dynamically as boom 20 rotates and/or extends.

Controller 48 may use one or more algorithms that include factors for a slope of the ground, the presence of any holes, weight load balance (e.g., on bucket 76 or attachment 30), changes in load (e.g., position or weight), the direction of wheels 14, operation of wheels 14, operation of boom 20, operation of attachment 30, and/or other vehicle feedback such as the engine, oil, or tire temperature or pressure.

Display 60 may also show the current position 88 (e.g., extension, height, and/or out-of-plane components X1, Y1, and/or Z1) of attachment 30. The current position 88 is displayed within a dynamically calculated digital load chart 58 that is dependent on the weight and/or position of load applied on attachment 30 and measured by load sensor 38.

Controller 48 uses the measured weight(s) to determine dynamic horizontal and/or vertical limits 78 of boom 20 extension and/or rotation. Controller 48 limits extension and/or rotation based on the weight measured by load sensor 38. Controller 48 sends electronic signals to an audio or visual alarm 62 to alert an operator when the extension and/or rotation is near, at, and/or extended beyond horizontal and/or vertical limits 78. An alarm 62 may be used to alerts near the load limits 78 and/or controller 48 may prevent operation of boom 20 beyond the load limits 78. When extension and/or rotation exceeds load limits 78, controller 48 can inhibit operation of any component on the vehicle including, but not limited to, wheels 14, track 124, lift arm 80, and/or lifter 82.

Controller 48 may also be configured to send electronic signals to a first alarm 62 when telescoping boom extends to within a percentage of the horizontal limit 78 and a second alarm 62 when boom 20 extends to within a percentage of the vertical limit 78. In various embodiments, the percentage is less than 75%, 80%, 85%, 90%, 95%, or 100% of horizontal and/or vertical limit 78.

Controller 48 may also provide an alarm 62 at extensions and/or rotations less than or equal to horizontal and/or vertical limit 78 and suspends operation (e.g., of wheels 14 and/or boom 20) when a horizontal or vertical limit 78 is reached. For example, controller 48 limits the operation of attachment 30 when boom 20 extension is equal to or greater than a horizontal and/or vertical limit 78. The operator can override controller 48 to operate the vehicle, even past limits 78. For example, operator overrides controller 48 when extension is more than 75%, 80%, 85%, 90%, 95%, 100%, 105%, 110%, 115%, 120%, or 125% of horizontal and/or vertical limit 78.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the invention will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes, and omissions may also be made in the design, operating conditions, and arrangement of the various exemplary embodiments without departing from the scope of the present invention.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths, and radii, as shown in the Figures, are to scale. Actual measurements of the Figures will disclose relative dimensions, angles, and proportions of the various exemplary embodiments. Various exemplary embodiments extend to various ranges around the absolute and relative dimensions, angles, and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description. In addition, in various embodiments, the present disclosure extends to a variety of ranges (e.g., plus or minus 30%, 20%, or 10%) around any of the absolute or relative dimensions disclosed herein or determinable from the Figures.

What is claimed is:

1. A light-transmitting system for determining an angle and an extension of a rotating and boom, the system comprising:
a base;
a boom having a first end coupled to the base and a second end extending away from the base;
a pivot coupling the boom to the base that rotates the boom relative to the base;
a reflector located on one of the base and the second end of the boom;
a transmitter located at the other of the base and the second end of the boom; and
a detector located adjacent to the transmitter on the other of the base and the second end of the boom.

2. The system of claim 1, further comprising a hydraulic extension cylinder coupled to the boom that extends the boom and a hydraulic rotation cylinder coupled to the boom that rotates the boom about the pivot.

3. The system of claim 1, further comprising wheels on the base, wherein the wheels drive and support the base.

4. The system of claim 1, further comprising a track on the base, wherein the track drives and supports the base.

5. The system of claim 1, wherein the reflector is located on the second end of the boom, and the transmitter and the detector are located on the base.

6. The system of claim 1, further comprising a load sensor and a controller, wherein the load sensor measures a load applied at the second end of the boom, and the controller determines a horizontal limit component and a vertical limit component of the boom.

7. The system of claim 6, wherein the controller limits the extension and the rotation of the boom based on the load measured by the load sensor.

8. The system of claim 6, wherein the controller sends electronic signals to an alarm that alerts an operator when the boom is extended beyond the horizontal limit component or the vertical limit component.

9. The system of claim 6, further comprising a display, wherein the display shows a dynamic digital load chart and illustrates a current position of the boom within the dynamic digital load chart.

10. The system of claim 9, wherein the dynamic digital load chart is dependent on the load applied at the second end of the boom as measured by the load sensor.

11. An infrared light-transmitting system for determining an angle and an extension of a rotating and telescoping boom, the system comprising:
a chassis;
a telescoping boom, the telescoping boom having a first end coupled to the chassis and a second end extending away from the chassis;
a pivot coupling the telescoping boom to the chassis that rotates the telescoping boom relative to the chassis;
a reflector located on one of the chassis and the second end of the telescoping boom;
a transmitter located at the other of the chassis and the second end of the telescoping boom; and
a detector located adjacent to the transmitter on the other of the chassis and the second end of the telescoping boom.

12. The system of claim 11, wherein the transmitter is an array of 1024 by 1024 infrared light beams.

13. The system of claim 11, wherein the transmitter has infrared light beams oriented in a height dimension and a width dimension, and wherein the width dimension is equal to or less than one-fourth the height dimension of the infrared light beams on the transmitter.

14. The system of claim 11, wherein the transmitter has infrared light beams oriented at a ground location near wheels coupled to the chassis, wherein the transmitter sends a signal to stop operation of the wheels when the ground location has a hole.

15. The system of claim 11, wherein the transmitter sends infrared light beams that are detected by the detector to determine a location of an object other than the reflector, wherein when the object is located between the chassis and the second end of the telescoping boom, the detector sends a signal to stop movement of the chassis.

16. The system of claim 11, further comprising a load sensor and a controller, wherein the load sensor measures a load applied at the second end of the telescoping boom, and the controller determines a horizontal limit component and a vertical limit component of the extension of the telescoping boom, and wherein the controller sends electronic signals that stop the extension of the telescoping boom when the horizontal limit component or the vertical limit component is reached.

17. The system of claim 11, further comprising a load sensor and a controller, wherein the load sensor measures a load applied at the second end of the telescoping boom, and the controller determines a horizontal limit component and a vertical limit component of the extension of the telescoping boom, and wherein the controller sends electronic signals to a first alarm when the telescoping boom extends to within 80% of the horizontal limit component and a second alarm when the telescoping boom extends to within 80% of the vertical limit component.

18. An infrared light-transmitting system for determining an angle and an extension of a rotating and telescoping boom, the system comprising:
a vehicle that includes:
wheels that move the vehicle;
a cab that at least partially surrounds an operator of the vehicle;
a chassis that supports the cab and couples to the wheels;
a telescoping boom, the telescoping boom coupled to the chassis at a first end and coupled to an attachment extending away from the chassis at a second end;
a pivot coupling the telescoping boom to the chassis, the telescoping boom rotates about the pivot relative to the chassis;
a reflector located on one of the vehicle and the attachment;
a transmitter located at the other of the chassis and the attachment; and
a detector located adjacent to the transmitter on the other of the chassis and the attachment of the telescoping boom.

19. The system of claim 18, wherein the attachment is a bucket coupled to the telescoping boom, and wherein the reflector is located on the bucket, and the transmitter and the detector are located on the chassis.

20. The system of claim 18, further comprising a platform, wherein the attachment is a pair of tynes that removably support the platform, wherein the wheels are coupled to a track that moves the vehicle, and wherein the reflector is located on at least one of the pair of tynes and the transmitter and the detector are located in the cab on the chassis.
